(19) United States
(12) Patent Application Publication
(10) Pub. No.: US 2024/0367343 A1
(43) Pub. Date: Nov. 7, 2024

(54) Form Liner For Concrete

(71) Applicant: Samuel Clyde Scott, III, Elizabeth, CO (US)

(72) Inventor: Samuel Clyde Scott, III, Elizabeth, CO (US)

(21) Appl. No.: 18/650,219

(22) Filed: Apr. 30, 2024

Related U.S. Application Data
(60) Provisional application No. 63/500,059, filed on May 4, 2023.

(51) Int. Cl. B28B 7/00; B28B 7/36

(52) U.S. Cl. CPC B28B 7/0073; B28B 7/368

(57) ABSTRACT

A form liner for concrete can be produced according to a manufacturing process. An example manufacturing process includes providing a substrate material, and then printing a barrier substance onto the substrate material in an outline form of a desired pattern. After printing the barrier substance, the example manufacturing process includes printing an expandable foam material in a liquid state between the outline form of the barrier substance. The expandable foam material is then cured such that the expandable foam material is stiffened on the substrate material between the outline form of the barrier substance to provide the desired pattern on the substrate material for use as the form liner for concrete.

### PRIORITY CLAIM

This application claims the priority filing benefit of U.S. Provisional Patent Application No. 63/500,059 filed May 4, 2023 for “Form Liner For Concrete” of Samuel Clyde Scott, III, hereby incorporated by reference in its entirety as though fully set forth herein.

### BACKGROUND

Concrete forms are available for horizontal and vertical surfaces. When the exposed concrete is the final finish, patterns can be imprinted on form liners that are attached to the inside of the forms prior to pouring the concrete into the form. When the forms and form liners are removed after the concrete cures, the pattern is visible on the cured concrete. Nearly any desired patterns can be imprinted on the concrete using this technique, including designs and even artwork. Brick, tile, stone, and other objects are commonly added to form liner pockets before pouring the concrete. When the concrete cures, these objects are embedded into the concrete, creating a veneer of that material.

Brick, tile, stone and other objects embedded into the concrete are often outside of the specified dimensional size range that is needed to make a proper seal between the edges of the form liner pockets and the objects themselves. This results in unsatisfactory leakage of the wet concrete into these pockets, or distorted joints in the final product.

When masonry coursing is hand laid, this problem is mitigated by evenly adjusting the module throughout the length of the course in order to fit evenly across the wall. Currently available form liners made to embed objects into the concrete have a fixed size pocket that is not easily adapted to variation within the same course or wall. An embedded brick installer may have to fit the particular brick, tile, stone, or other object into a pocket in the concrete liner that is either too small or too large. Often this requires cutting of the objects at the end of a row or course of brick, tile, stone, and other objects. Very often, the disruption to the otherwise even coursing is visually less attractive, or possibly unacceptable.

### BRIEF DESCRIPTION OF THE DRAWINGS

FIG. 1 illustrates a form liner for concrete produced according to a manufacturing process, wherein a barrier substance is printed onto a substrate material in an outline form of a desired pattern.

FIG. 2 shows the form liner for concrete produced according to a manufacturing process as shown in FIG. 1, wherein the barrier substance has been printed onto the substrate material in outline form of the desired pattern.

FIG. 3 illustrates a form liner for concrete produced according to a manufacturing process, wherein an expandable foam material in a liquid state is printed between the outline form of the barrier substance shown in FIG. 2.

FIG. 4 is a perspective view of a portion of the desired pattern from FIG. 3 following curing of the expandable foam material such that the expandable foam material is stiffened on the substrate material between the outline form of the barrier substance to provide the desired pattern on the substrate material for use as the form liner for concrete.

FIG. 5 is a top view of the portion of the desired pattern as shown in FIG. 4.

FIG. 6 is another top view of the portion of the desired pattern as shown in FIG. 5, after a texture or object has been inserted into the form liner for concrete.

FIG. 7 is an isometric view of a portion of the cured expandable foam material and barrier substance on the substrate material.

FIG. 8 is a cross-sectional view of the portion of the cured expandable foam material and barrier substance on the substrate material corresponding to FIG. 7.

FIG. 9 is a cross-sectional view of the portion of the cured expandable foam material and barrier substance on the substrate material corresponding to FIG. 8, after a texture or object has been inserted into the form liner for concrete for example as shown in FIG. 6.

### DETAILED DESCRIPTION

A form liner for concrete is disclosed as it may be produced according to example manufacturing processes described herein. An example manufacturing process includes providing a substrate material, and then printing a barrier substance onto the substrate material in an outline form of a desired pattern. After printing the barrier substance, the example manufacturing process includes printing an expandable foam material in a liquid state between the outline form of the barrier substance. The expandable foam material is then cured such that the expandable foam material is stiffened on the substrate material between the outline form of the barrier substance to provide the desired pattern on the substrate material for use as the form liner for concrete. In an example, the substrate material may include a texture. Texture panels and/or texture objects and/or blockouts can also be added to the form liner by positioning these between the cured foam material.

An example form liner for concrete produced according to the manufacturing process described herein includes a suitable substrate (e.g., from a roll), which may have a desired texture or pattern thereon. In an example, the form liner may be an adaptable composite form liner. A barrier substance, such as grease, gel, or other suitable material, is dispensed as a barrier to form a reservoir for the foam that is dispensed in a liquid state, keeping the foam in the desired position as it expands. The barrier substance also creates an undercut on the joint profile to accommodate embedded brick or tile or other embeddable object. A liquid foam is dispensed inside the barriers that were created by the barrier substance. The foam expands, stiffens and creates the desired design. Once the foam is cured, the composite of backing and adhered foam is trimmed to specifications and any identifying markings can be added.

The finished form liner has the desired design printed onto a substrate that can accept objects to be embedded, or stand alone designs that do not have embedded objects and are instead indentations molded directly into the concrete.

The finished form liner fits the bricks with variation in the run by compressing the foam to allow variation from pocket to pocket. This allows the installer to utilize one continuous sheet of the pocket matrix form liner in an order and design that will accommodate the individual shapes he or she wishes to embed into the concrete, regardless of variations of size and shape of the objects.

In an example, the form liner can be customized to the particular job. It is capable of adjustments in size and coursing that pre-formed modular form liners cannot be readily adapted to.

In an example, the form liner reduces the number of parts needed for a panel, because everything can be printed on the substrate material (e.g., a long sheet or a roll). The form liner is suitable for larger sized sheets than vacuum formed plastic form liners, which can reduce the number of sheets needed for each job.

In an example, the form liner may include an integrated concrete cure retardant in the pocket, thereby reducing or eliminating the need to wax or otherwise coat the bricks or other objects to be embedded.

In an example, the form liner produces a fully customizable form liner that can have multiple designs and patterns, all printed on the same substrate.

In an example, the flexible joint of the form liner fits objects to be embedded that are either too long or too short or irregular.

In an example, the form liner does not experience thermal expansion or contraction that is common with plastic single use formliners.

In another example, a desired pattern can be printed directly on the substrate without the barrier material and without having to add texture panels or other objects. That is, the production method may be implemented to print the entire design for the form liner for concrete. In an example, a form liner for concrete is produced according to a manufacturing process. A substrate material is provided, e.g., for the printing device. An expandable foam material is provided in a liquid state and printed onto the substrate material in a desired pattern(s). The expandable foam material is cured such that the expandable foam material is stiffened and forms an impression design on the substrate material to provide the desired pattern for use as the form liner for concrete.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

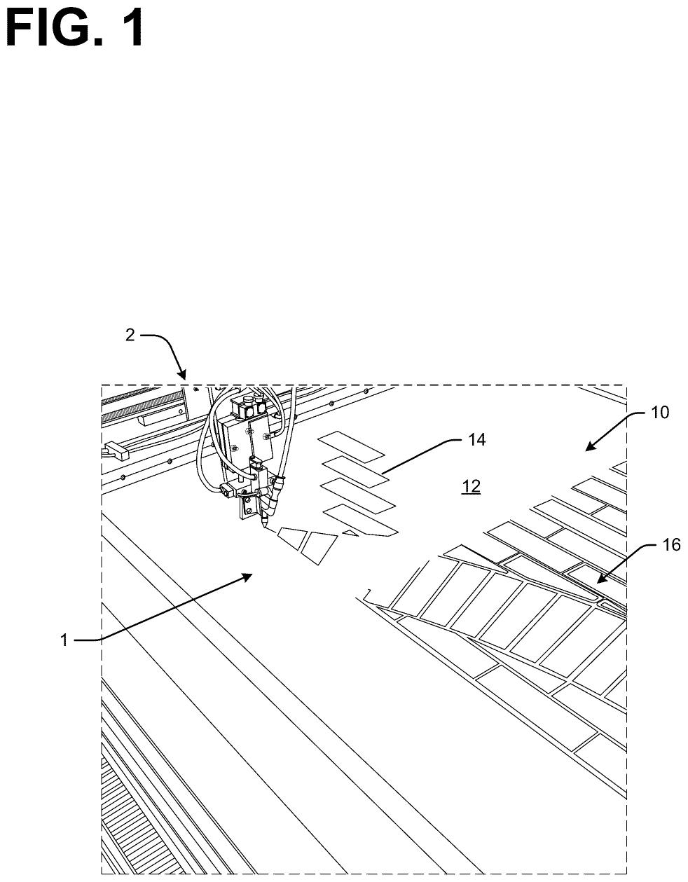

FIG. 1 illustrates a form liner 10 for concrete produced according to a manufacturing process. An example form liner 10 includes a sheet or roll of paper or plastic or other substrate material 12. The substrate material 12 is loaded into a printing area 1 of a printing machine 2 (e.g., of a 3D printer). A barrier substance 14 is printed or otherwise applied onto the substrate material 12 in an outline form of a desired pattern 16. The pattern may be provided according to a computer Aided Design (CAD) file or other configuration pattern.

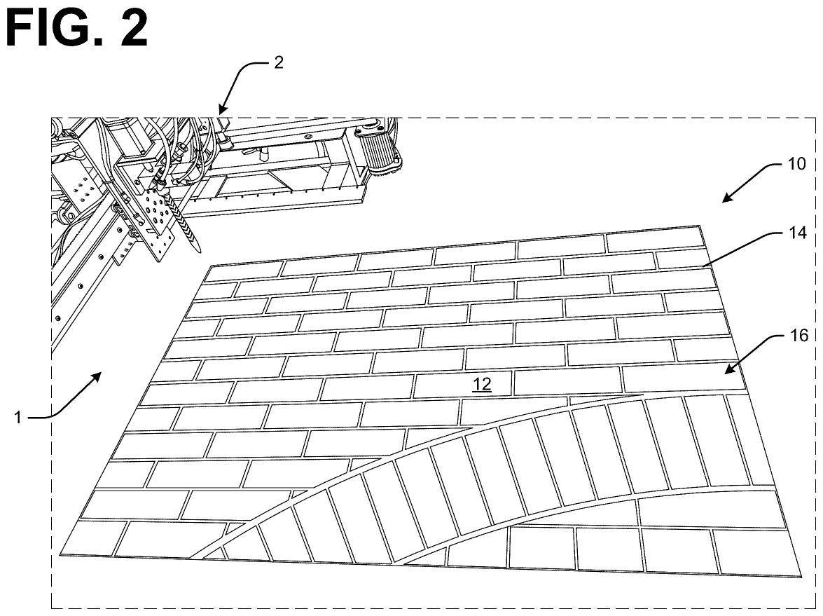

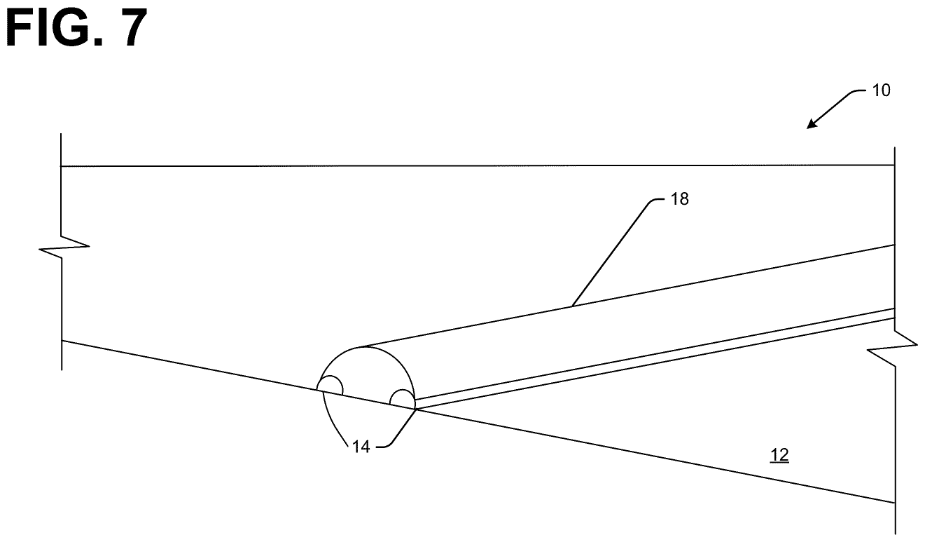

FIG. 2 shows the form liner 10 for concrete produced according to a manufacturing process as shown in FIG. 1. In FIG. 2, the barrier substance 14 is shown as it has been printed onto the substrate material 12 in outline form of the desired pattern 16. The barrier substance 14 may be dispensed as a barrier that creates an undercut on the joint profile to accommodate embedded brick or tile or other embeddable object, as will be described in more detail below with reference to FIGS. 7-9.

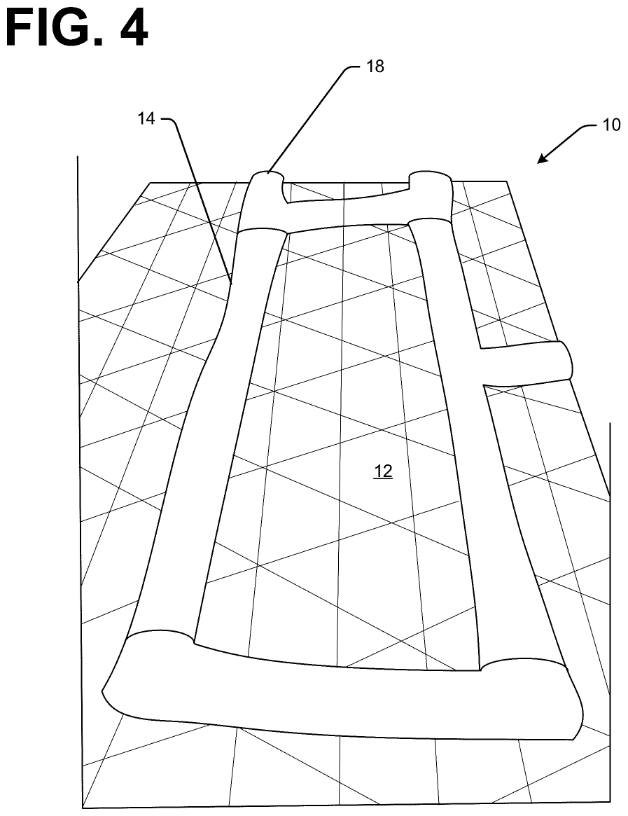

It is noted that some faux products do not require the use of the barrier substance 14. When provided, however, the barrier substance 14 may also serve as a barrier (or wall or dam) as seen in FIG. 4. These walls form a reservoir (i.e., the space between adjacent walls) for an expandable foam 18 that is dispensed in a liquid state into this space (or reservoir). This helps keep the expandable foam 18 in the desired position on the substrate 12 as it expands during curing.

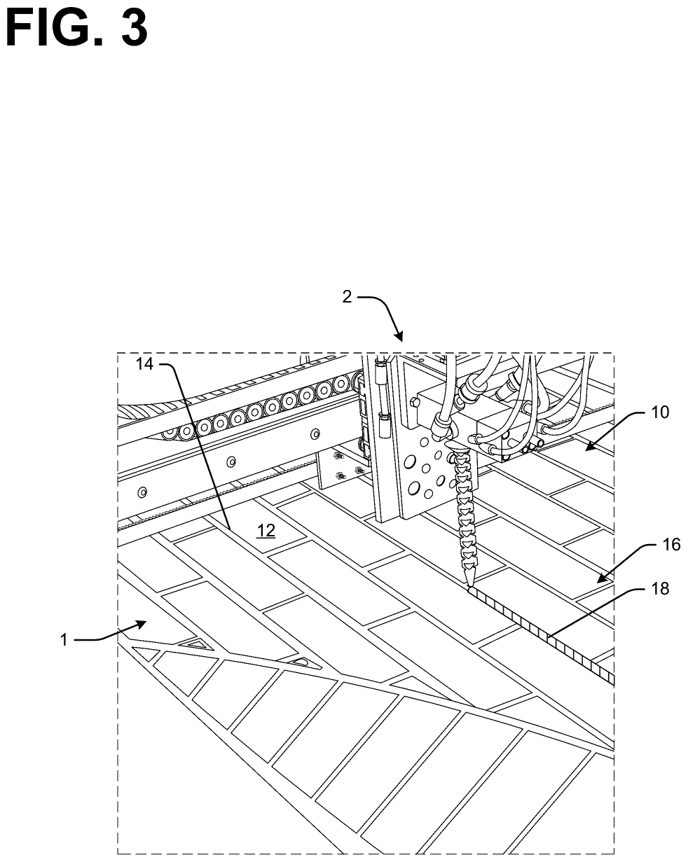

The expandable foam material 18 is printed onto the substrate material 12 in a liquid state between the walls formed by the barrier substance as an outline of the design pattern 16. FIG. 3 illustrates a form liner 10 for concrete produced according to a manufacturing process, wherein the expandable foam material in a liquid state is printed between the walls formed by the barrier substance 14 according to the design pattern 16 as shown in FIG. 2. In an example, the liquid foam material 18 is dispensed inside the barrier walls that were created by the barrier substance 14. As the liquid foam 18 cures, it expands and stiffens within the barrier walls and forms to the desired design pattern 16. In an example, the foam material 18 is printed to serve as a grout line in the desired pattern 16.

The expandable foam material 18 is cured, such that the expandable foam material 18 is stiffened on the substrate material 12 between the outline form of the barrier substance 14 to provide the desired pattern 16 on the substrate material 12 for use as the form liner 10 for concrete. FIG. 4 is a perspective view of a portion of the desired pattern from FIG. 3 following curing of the expandable foam material 18. As the expandable foam material 18 cures, it stiffens on the substrate material 12 between the outline form of the barrier substance 14 to provide the desired pattern 16 on the substrate material for use as the form liner 10 for concrete.

After the foam material 18 is cured, the composite of substrate material 12 and adhered foam 18 is trimmed to exact specifications for the job, and any identifying markings and/or texture are added (e.g., by laser or cnc router). The finished form liner 10 has the desired design printed onto a substrate 12 that can accept texture, objects to be embedded therein, or as a stand-alone design (i.e., does not have embedded objects, but instead has texture and/or indentations that will be molded directly from the form liner 10 into the concrete that comes into contact with the form liner 10.

In an example, the form liner 10 is adaptable or customizable during manufacture to accommodate size and spacing requirements and/or irregularities that the installer may encounter on the job site.

In an example, the form liner 10 can be produced on large, continuous substrate 12 such as rolls, in very large/long sections, and/or to accommodate particular sizes and/or shapes encountered at the job site.

In an example, the barrier substance 14 may also serves to form a gasket for any embedded objects that are added, and creates a joint that is bonded in the center (between the foam 18 and the substrate 12), while the upper portion of the foam 18 mushrooms out to create a better seal around different size and/or irregular shaped objects.

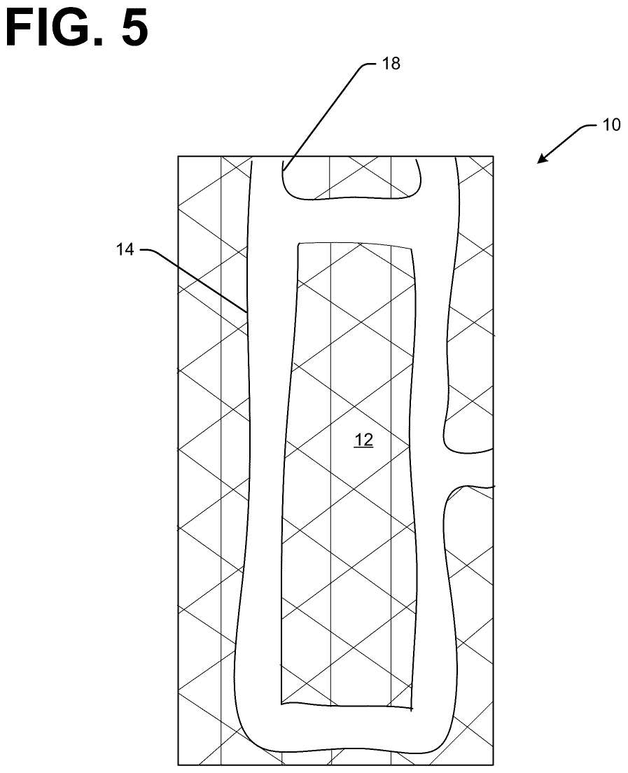

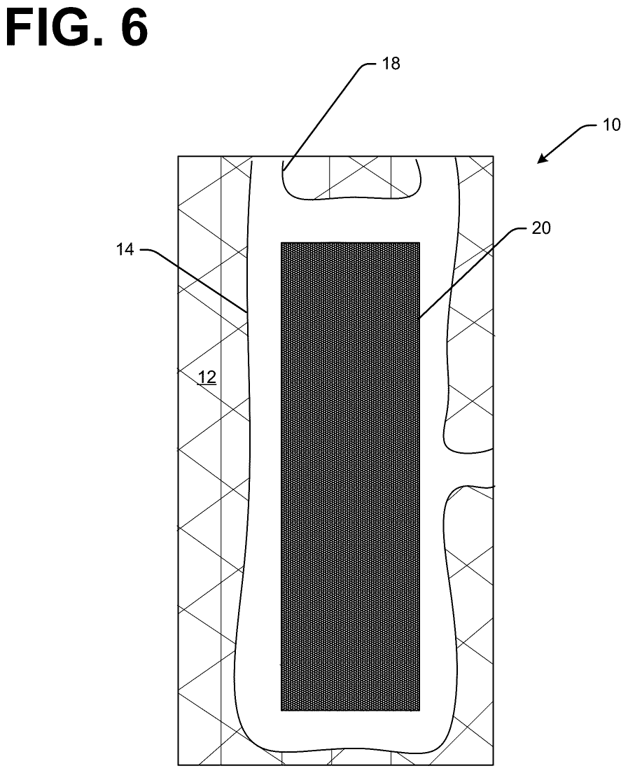

In an example, the substrate material 12 is provided having a surface texture prior to printing operations. That is, the substrate material 12 itself has a texture (e.g., impressions of stone, brick, wood, etc.) on the substrate material 12. This texture may be formed as part of the substrate material 12 or added onto the substrate material. In another example, the substrate material 12 is provided with a surface texture after printing operations. In another example, texture impressions and/or objects (e.g., an actual rock or brick, or a blockout to add an actual rock or brick) are provided onto the substrate material 12, between the foam walls, for example as illustrated in FIGS. 5 and 6.

FIG. 5 is a top view of the portion (e.g., an impression area for a “brick”) of the desired pattern 16, as shown in FIG. 4. FIG. 6 is another top view of the portion (e.g., the impression area for the “brick”) of the desired pattern 16, as shown in FIG. 5. FIG. 6 shows an object 20 (e.g., the “brick”) that has been inserted into the form liner 10 for concrete. The object may be a texture panel or a texture block, a faux object (e.g., a faux rock or faux brick), or a blockout for adding an actual object such as an actual rock or actual brick or portion thereof.

In an example, the cured expandable foam material forms a “flexible joint” on the substrate material. By way of illustration, in FIGS. 5 and 6 it can be seen that object 20 has been pressed into the area formed between the foam walls. The foam is compressible as the object 20 is pressed therein, so as to fit or accommodate the object 20 and hold the object 20 snuggly therein. It is noted that barrier substance 14 provides a lip that enables the foam to compress even more than if it were adhered to the substrate material 12 at the edges. That is, the barrier substance 14 keeps the edges of the foam material 18 from attaching to the substrate material 12 at the edges, thus enabling the foam material 18 to compress or press toward the center of the foam wall for receiving the object 20 therein. The foam wall, in a compressed state, thus naturally expands outward against the object 20 that has been inserted therein, to hold or retain the object 20 therein. This can be seen with reference to FIGS. 7-9.

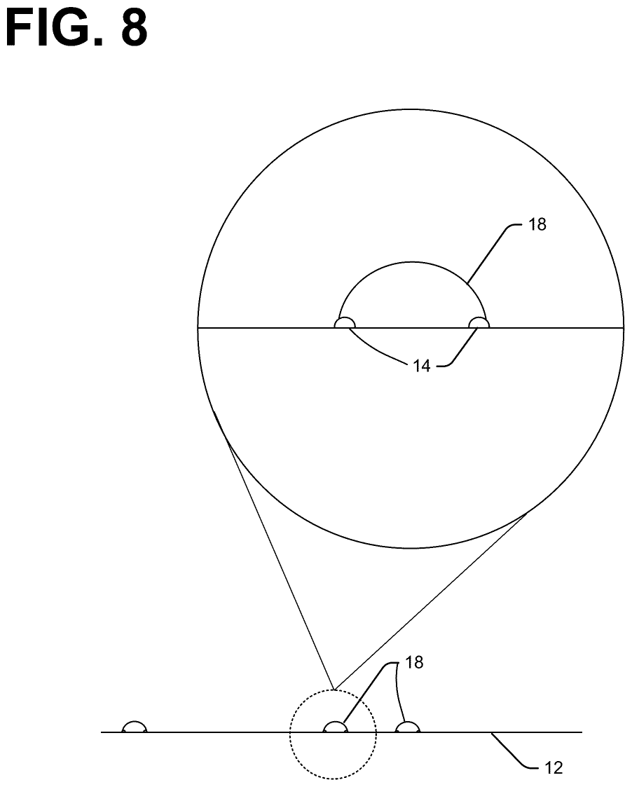

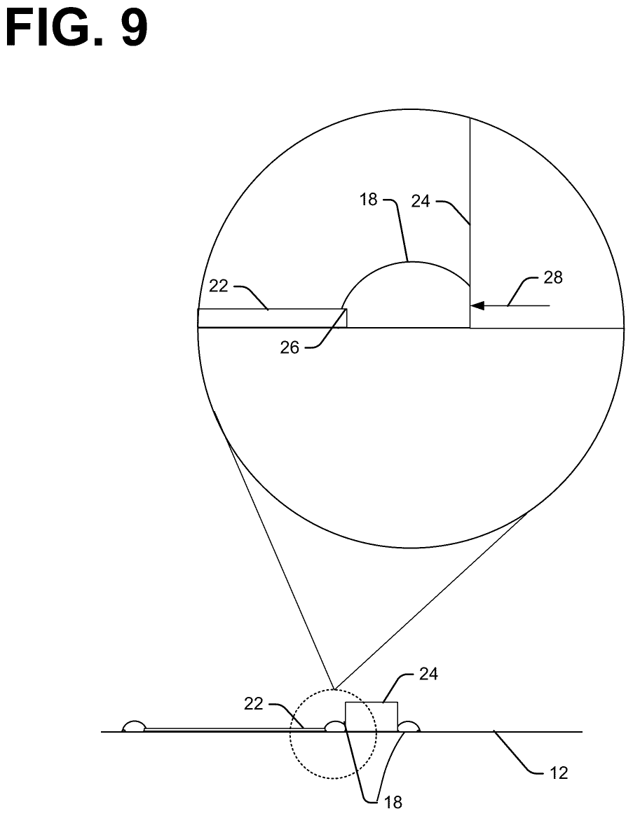

FIG. 7 is an isometric view of a portion of the cured expandable foam material 18 and barrier substance 14 on the substrate material 12. FIG. 8 is a cross-sectional view of the portion of the cured expandable foam material 18 and barrier substance 14 on the substrate material 12 corresponding to FIG. 7. FIG. 9 is a cross-sectional view of the portion of the cured expandable foam material 18 and barrier substance 14 on the substrate material 12 corresponding to FIG. 8. FIG. 9 shows the form liner 10 after a texture panel 22 and/or object 24 (e.g., faux object, actual object, or blockout object) has been inserted into the form liner 10, for example the object 20 as shown in FIG. 6.

In an example, a pocket can be formed in the desired pattern on the substrate material by means of a blockout object (e.g., object 24). It is noted that the term “blockout” object, as used herein, refers to a container that will form an opening or cavity in the concrete, the cavity configured to receive a faux object and/or actual object (or remain open as a cavity) in the finished concrete product. The blockout object may be solid, or may itself have a cavity formed therein (e.g., be at least partially hollow). The blockout object may be removed from the finished concrete product, or left in the finished concrete product, depending on the specifications of the finished product.

In an example, a concrete curing retardant can be provided into the pocket in the desired pattern on the substrate material. This can help to reduce or eliminate a need for waxing or otherwise coating an object to be embedded in the pocket so that the object does not adhere to the form or concrete, and reduces or eliminates leakage sticking to the face of the embedded object (not to keep it from sticking to the form).

FIGS. 7-9 illustrate the profile of an example undercut joint that can be formed to accommodate a texture form or texture panel 22, and/or an object 24 such as a faux object, an actual object, or a blockout form for a separately embeddable object. A texture form or a texture panel 22, as those terms are used interchangeably herein, refers to a panel having a desired texture imprint that is inserted onto the substrate 12 between the foam walls. In an example, the texture panel 22 can be pressed between the foam walls, as described above with reference to the objects. In another example, an undercut joint profile (see, e.g., FIGS. 8 and 9) having an overhanging ledge 26 is formed under which the edges of a texture form or texture panel 22 can be fitted, as seen in FIG. 9. The textures described herein are those texture imprints intended to be molded directly into the concrete and result in a desired texture on the finished concrete product.

As described above, the flexible joint is compressed by the texture panel 22 by pressing the texture panel 22 between the cured expandable foam material 18. In another example, the flexible joint is compressed by pressing an object 24 between the cured expandable foam material 18 (e.g., in the direction of arrow 28 shown in FIG. 9.

It is noted that when a barrier material 14 is not used during the manufacture process, that the cured foam 18 may still give sufficiently such that a texture panel 22 and/or object 24 can be inserted therein and compress the foam 18 to retain the texture panel 22 and/or object 24 therebetween.

In an example, the form liner 10 for concrete can be customized for a particular customer or job. For example, the size of the form liner for concrete can be designed, sized, and/or fitted or adjusted to a particular location at a job. In another example, the coursing of the form liner for concrete can be adjusted for particular jobs.

It is noted that the examples shown and described are provided for purposes of illustration and are not intended to be limiting. Still other examples are also contemplated.

1. A form liner for concrete produced according to a manufacturing process, comprising:
providing a substrate material;
printing a barrier substance onto the substrate material in an outline form of a desired pattern;
printing an expandable foam material in a liquid state between the outline form of the barrier substance; and
curing the expandable foam material such that the expandable foam material is stiffened on the substrate material between the outline form of the barrier substance to provide the desired pattern on the substrate material for use as the form liner for concrete.

2. The form liner of claim 1, wherein the cured expandable foam material forms a flexible joint on the substrate material.

3. The form liner of claim 2, further comprising compressing the flexible joint by pressing a texture form between the cured expandable foam material.

4. The form liner of claim 2, further comprising compressing the flexible joint by pressing a blockout form between the cured expandable foam material.

5. The form liner of claim 2, further comprising compressing the flexible joint by pressing an embeddable object between the cured expandable foam material.

6. The form liner of claim 1, further comprising adding identifying markings to the form liner for concrete by laser or cnc router.

7. The form liner of claim 1, forming an undercut joint profile to accommodate a blockout form for an embeddable object.

8. The form liner of claim 1, forming an undercut joint profile to accommodate a texture form to be molded directly into the concrete.

9. The form liner of claim 1, providing the substrate material with a surface texture prior to printing operations.

10. The form liner of claim 1, providing the substrate material with a surface texture after printing operations.

11. The form liner of claim 1, wherein the expandable foam material is printed as a grout line of the desired pattern.

12. The form liner produced according to a manufacturing process of claim 1, further comprising forming a reservoir with the barrier substance for the expandable foam material to retain the expandable foam material in the liquid state in a desired position on the substrate material during curing of the expandable foam material.

13. The form liner produced according to a manufacturing process of claim 1, further comprising customizing the form liner for concrete to a particular job.

14. The form liner produced according to a manufacturing process of claim 13, further comprising customizing a size of the form liner for concrete

15. The form liner produced according to a manufacturing process of claim 13, further comprising customizing a coursing of the form liner for concrete

16. The form liner produced according to a manufacturing process of claim 1, wherein providing the substrate material is on a substrate sheet.

17. The form liner produced according to a manufacturing process of claim 1, wherein providing the substrate material is on a substrate roll.

18. The form liner produced according to a manufacturing process of claim 1, further comprising forming a pocket in the desired pattern on the substrate material.

19. The form liner produced according to a manufacturing process of claim 18, further comprising integrating a concrete curing retardant into the pocket in the desired pattern on the substrate material, to reduce or eliminate a need for waxing an object to be embedded in the pocket.

20. A form liner for concrete produced according to a manufacturing process, comprising:
providing a substrate material;
printing an expandable foam material in a liquid state in a desired pattern on the substrate material; and
curing the expandable foam material such that the expandable foam material is stiffened and forms an impression design on the substrate material to provide the desired pattern for use as the form liner for concrete.
